(19) United States
(12) Patent Application Publication
(10) Pub. No.: US 2025/0174992 A1
(43) Pub. Date: May 29, 2025

(54) POWER SYSTEM

(71) Applicant: LS ELECTRIC CO., LTD., Anyang-si, Gyeonggi-do (KR)

(72) Inventors: Seungwoon LEE, Anyang-si, Gyeonggi-do (KR); Seonghyeon KIM, Anyang-si, Gyeonggi-do (KR)

(21) Appl. No.: 18/842,444

(22) PCT Filed: Mar. 17, 2023
(86) PCT No.: PCT/KR2023/003568

§ 371 Date: Aug. 29, 2024

(30) Foreign Application Priority Data
Apr. 27, 2022 (KR) 10-2022-0052306

(51) Int. Cl. H02J 3/12; B60L 53/53; B60L 53/54; B60L 53/62; B60L 53/63; B60S 5/02; H01M 16/00; H02J 3/00; H02J 3/38

(52) U.S. Cl. CPC H02J 3/12; B60L 53/53; B60L 53/54; B60L 53/62; B60L 53/63; H01M 16/006; H02J 3/003; H02J 3/38; B60S 5/02; H01M 2220/20; H01M 2250/20; H01M 2250/402; H02J 2300/30; H02J 2310/12

(57) ABSTRACT

The present disclosure relates to a power system comprising: a power unit for supplying power to a load in a building; an electric vehicle charging unit for receiving power from the power unit and charging an electric vehicle to be charged; and a control unit for controlling operations of the power unit and the electric vehicle charging unit by monitoring consumption of the load and charging of the electric vehicle. The power unit includes: a first supply unit receiving commercial power from a system connected to the building; and one or more second supply units installed in the building to self-supply power.

### TECHNICAL FIELD

The present disclosure relates to a power system for a building having electric vehicle charging facilities.

### BACKGROUND ART

The technical background of the present disclosure relates to a power system for charging electric vehicles, and specifically, to a system for charging electric vehicles in buildings in which various energy sources are disposed.

Coupling of various energy sources is being attempted around the world, and the proportion of electric vehicles is increasing. In this situation, various types of electric vehicle chargers are being integrated with existing power facilities.

Electric vehicle charging loads are increasing very quickly, but are not connected to upper power facilities and thereby operate only as loads. However, when an electric vehicle load peak and a general load peak conflict with each other, power outages and fire accidents may occur due to overload, or a peak rate increases significantly to thereby cause an increase in electricity bills.

In preparation for this, a method of coupling various energy sources, including solar power generator, hydrogen fuel generator, and ESS, has been presented.

FIG. 1 illustrates the configuration of the related art power system that supports charging of electric vehicles and charging of hydrogen vehicles by mutually exchanging electricity between ESS and fuel cells for electric charging and hydrogen charging.

The method of producing and storing hydrogen by receiving power from the ESS of the related art system has uneconomical limitations. In addition, charging stations are required to be installed in large residential areas such as apartment complexes and parking buildings, so it is necessary to connect them with building energy systems, but no technology has been proposed to enable efficient connection with the building energy systems. Furthermore, as the system configuration becomes more complex due to the inclusion of various energy sources, there is a limitation that reduces the stability of a system operation. In addition, various fluctuations occur due to the increase in various energy sources and various loads, and appropriate technologies to respond to these fluctuations have not been proposed, leading to difficulties in the system operation.

### DISCLOSURE OF INVENTION

### Technical Problem

The present disclosure is directed to solving the problems described above.

In other words, the present disclosure is directed to securing stable charging of electric vehicles within a specific area, such as a building, in which various energy sources are provided.

Therefore, the present disclosure is directed to providing an embodiment of a power system that is capable of stably supplying power to loads and charging electric vehicles within a specific area including various energy sources.

In addition, the present disclosure is directed to providing an embodiment of a power system that is capable of responding appropriately to various load fluctuations that occur within a specific area.

Furthermore, the present disclosure is directed to providing an embodiment of a power system that is capable of suppressing fluctuations due to coupling of a plurality of energy sources.

### Solution to Problem

To solve those problems, there is provided a power system including a power unit that supplies power to a load within a specific area, an electric vehicle charging unit that receives power from the power unit and charges an electric vehicle to be charged, and a control unit that monitors power consumption of the load and charging of the electric vehicle and controls operations of the power unit and the electric vehicle charging unit, wherein the power unit includes a first supply unit that receives commercial power from a system connected to the specific area, and at least one second supply unit that is installed in the specific area to supply its own power, the control unit determines a predicted power consumption value of the load and a predicted power charging value of the electric vehicle based on a power consumption history of the load and a power charging history of the electric vehicle, and controls an operation of the at least one second supply unit according to the predicted power consumption value and the predicted power charging value, so as to control a power supply to the load and power charging of the electric vehicle.

In one embodiment, the at least one second supply unit may include at least one of a fuel cell part, a battery part, and a renewable energy part.

In one embodiment, the control unit may distribute a supply value to the load and a charging value of the electric vehicle at a certain ratio when a sum of the predicted power consumption value and the predicted power charging value exceeds a certain reference value, and control the power supply and power charging according to the distributed ratio.

In one embodiment, when distributing the supply value and the charging value at the certain ratio, the control unit may distribute the supply value and the charging value according to at least one of a degree to which the sum exceeds the certain reference value and a ratio of the predicted power consumption value and the predicted power charging value.

In one embodiment, when distributing the supply value and the charging value at the certain ratio, the control unit may determine a status level based on a real-time power consumption value of the load and a real-time power charging value of the electric vehicle, and distribute the supply value and the charging value according to a reference ratio corresponding to the status level.

In one embodiment, the at least one second supply unit may be provided in plurality each including at least two of the fuel cell part, the battery part, and the renewable energy part, each provided by at least one.

In one embodiment, the control unit may control an operation of at least one of the plurality of second supply units.

In one embodiment, the control unit may control power to be received and supplied between the plurality of second supply units.

In one embodiment, when controlling the operation of the at least one second supply unit, the control unit may calculate a virtual inertia according to an operation of a supply unit to be operated based on information about statuses of the system, the electric vehicle charging unit, and the power unit, and operate the supply unit to be operated for the power supply and the power charging by reflecting the virtual inertia.

In one embodiment, the control unit may calculate the virtual inertia based on information related to at least one of voltage, current, power, frequency, power factor, and load of each of the system and the power unit.

In one embodiment, the control unit may calculate the virtual inertia as a value that power supplied by the supply unit to be operated is synchronized with power supplied by the first supply unit.

In one embodiment, the control unit may determine the supply unit to be operated according to a real-time power consumption value of the load and a real-time power charging value of the electric vehicle, and operate the supply unit to be operated for the power supply and the power charging.

In one embodiment, the control unit may monitor changes in the virtual inertia and control the operation of the power supply and the power charging in response to the changes in the virtual inertia.

In one embodiment, when the virtual inertia corresponds to a certain reference range, the control unit may generate notification information about the virtual inertia corresponding to the reference range and controls the notification information to be displayed externally.

In one embodiment, the at least one second supply unit may include at least a fuel cell part, and the power system may further include a hydrogen vehicle charging unit that receives hydrogen from the fuel cell part and charges the hydrogen to a hydrogen vehicle to be charged.

In one embodiment, the control unit may determine the predicted power consumption value, the predicted power charging value, and a predicted hydrogen charging value of the hydrogen vehicle based on the power consumption history, and the power charging history, and a hydrogen charging history of the hydrogen vehicle, and control the operation of the at least one second supply unit according to the predicted power consumption value, the predicted power charging value, and the predicted hydrogen charging value, so as to control the power supply to the load, the power charging of the electric vehicle, and hydrogen charging of the hydrogen vehicle.

### Advantageous Effects of Invention

According to an embodiment of the present disclosure, operations of power supply sources can be controlled according to a predicted consumption value of a load and a predicted charging value of an electric vehicle, thereby enabling appropriate power supply and power charging according to a status of a load within a building.

In addition, by operating various power supply sources by reflecting a virtual inertia, an effect can be achieved that the operation of the power supply sources can be performed stably.

Accordingly, electric vehicles can be recharged stably, and various power supply sources can be used so as to achieve stable and efficient power supply and power charging through such various power sources, thereby enabling efficient energy consumption in buildings.

### BRIEF DESCRIPTION OF DRAWINGS

FIG. 1 is a block diagram illustrating an example of the related art power system of charging electric vehicles and hydrogen vehicles.

FIG. 2 is a block diagram illustrating the configuration of a power system according to an embodiment.

FIG. 3 is a block diagram illustrating a plurality of second supply units according to a specific embodiment.

FIG. 4 is a block diagram of a control unit according to a specific embodiment.

FIG. 5 is a flowchart illustrating the control of a power system according to a specific embodiment.

FIG. 6 is an exemplary view to which the embodiment is applied.

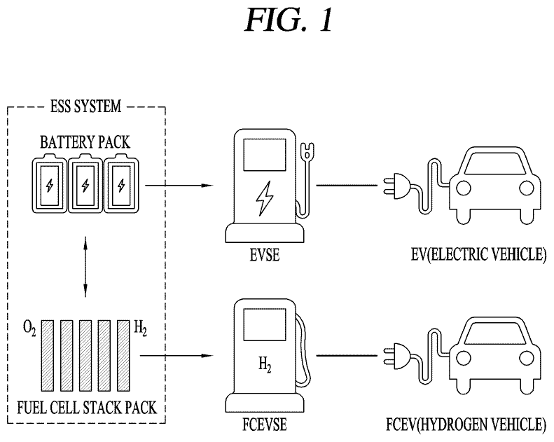

### MODE FOR THE INVENTION

Hereinafter, embodiments of the present disclosure will be described in detail with reference to the accompanying drawings. The same or similar components will be provided with the same or similar reference numerals, and explanations thereof will be omitted.

In describing the technology disclosed herein, if a detailed explanation for a related known technology is considered to unnecessarily divert the gist of the present disclosure or such related known technology is easily understood or inferred by those skilled in the art without a detailed description, such explanation will be omitted. It should be noted that the attached drawings are provided to help understanding of the embodiments disclosed herein, and should not be construed as limiting the technical idea disclosed in this disclosure by the attached drawings.

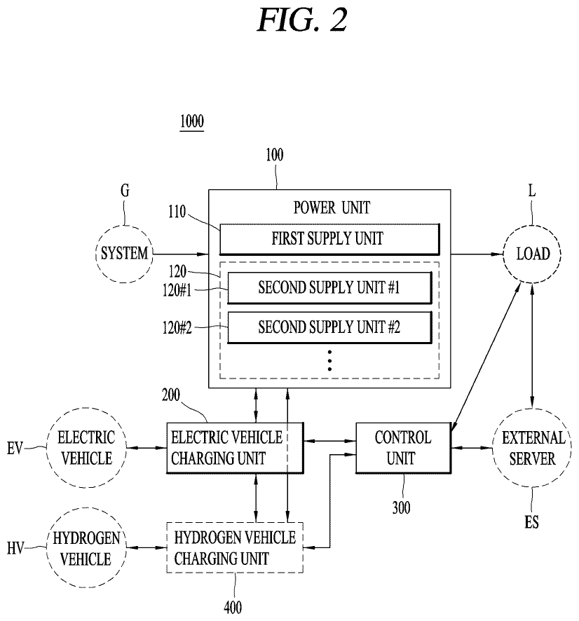

Hereinafter, a power system according to an embodiment of the present disclosure will be described with reference to FIGS. 2 to 6.

As illustrated in FIG. 2, the power system 1000 includes a power unit 100, an electric vehicle charging unit 200, and a control unit 300.

The power system 1000, which includes the power unit 100, the electric vehicle charging unit 200, and the control unit 300, refers to a power system that receives power from a plurality of power sources and consumes the received power.

The power system may be a power system applied to a building area including one or more buildings or a specific area outdoors.

For example, the power system may be a power system of a building that includes at least one of an indoor parking area and an outdoor parking area.

Here, the building may be a building equipped with a charging facility for electric vehicles (EVs), and the charging facility may correspond to the electric vehicle charging unit 200.

The power unit 100 supplies power to a load L within the specific area.

The load L may be a facility that is installed in the specific area and consumes power.

The load L may be provided in plurality, and may include all equipment, which consume power, including lighting equipment, electric equipment, communication equipment, and air conditioning equipment installed in the specific area.

The power unit 100 includes a first supply unit 110 that receives commercial power from a system G to which the specific area is connected, and a second supply unit 120 that is installed in the specific area and supplies power by itself.

Here, the system G may mean a power grid through which a power supplier supplies generated power.

The system G may be an infinite wireless system including one or more power generation, power transmission, substation, power distribution, power reception, and load.

The system G may be connected to the specific area and at least one target (power supply target) to which power is to be supplied other than the specific area, and may supply commercial power to the connected power supply target.

The system G may be connected to a plurality of electric facilities including the specific area, power systems, and loads, to receive and supply various types of power. This may cause fluctuations of the commercial power supplied to the power supply target.

The commercial power may be power in which at least one of voltage, current, power factor, and frequency corresponds to a specific supply standard.

For example, the commercial power may be power at a frequency of 60±x[HZ].

The first supply unit 110 may supply power to the load L by receiving the commercial power from the system G.

That is, the first supply unit 110 may be a device that supplies power to the load L by receiving the commercial power.

The first supply unit 110 may convert the commercial power into a type to be supplied to the load L and supply the converted power to the load L.

The first supply unit 110 may include at least one power conversion device and at least one power supply device to supply power to the load L.

The first supply unit 110 may also supply power to the electric vehicle charging unit 200.

Accordingly, the electric vehicle charging unit 200 may charge an electric vehicle (EV) (target electric vehicle) to be charged with power.

The second supply unit 120 may be installed in the specific area and supply its own generated power to the load L.

That is, the second supply unit 120 may be a self-power supply source that is installed in the specific area.

The second power supply unit 120 may be at least one (one or more).

The second power supply unit 120 may preferably be provided in plurality.

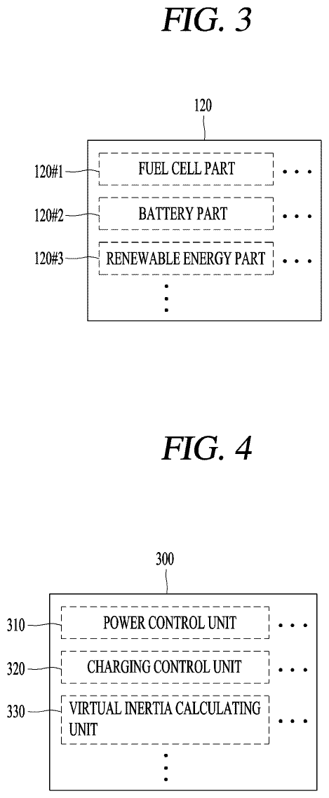

As illustrated in FIG. 3, the second supply unit 120 may include at least two of a fuel cell part 120#1, a battery part 120#2, and a renewable energy part 120#3, and each of the at least two parts may be at least one.

The fuel cell part 120#1 may be a hydrogen fuel cell that supplies power produced using the reverse reaction of electrolysis.

The battery part 120#2 may be a battery that stores power and supplies the stored power.

The renewable energy part 120#3 may be a solar light or solar heat power generation facility that supplies power generated using solar energy.

When the second supply unit 120 is provided in plurality, each of the plurality of second supply units 120 may convert its own power into a form that can be supplied to the load L, and supply the converted power to the load L.

The at least one second supply unit 120 may include at least one power conversion device and at least one power supply device, to supply power to the load L.

The at least one second supply unit 120 may also supply power to the electric vehicle charging unit 200.

Accordingly, the electric vehicle charging unit 200 may charge a target electric vehicle (EV) with power.

The power unit 100 including the first supply unit 110 and the at least one second supply unit 120 may be controlled by the control unit 300 to supply power to the load L and the electric vehicle charging unit 200.

The power unit 100 may also supply driving power to the control unit 300, and additionally transmit information about the status and operation thereof or information about power supply therefrom to the control unit 300.

The electric vehicle charging unit 200 charges the target electric vehicle EV with power received from the power unit 100.

The electric vehicle charging unit 200 may receive power from the first supply unit 110 and at least one of the plurality of second supply units 120, and charge the target electric vehicle EV with the received power.

The electric vehicle charging unit 200 may be controlled by the control unit 300 to supply power to the electric vehicle charging unit 200.

The control unit 300 controls the operations of the power unit 100 and the electric vehicle charging unit 200 by monitoring consumption of the load L and charging of the electric vehicle EV.

The control unit 300 may also control the operations of the power unit 100 and the electric vehicle charging unit 200 by monitoring the status of the system G and the status of the power unit 100.

The control unit 300 may refer to a central control device of the specific area.

For example, the control unit 300 may be a control device or integrated control device for the building.

Additionally, the control unit 300 may refer to a control system including at least one control device that perform power control.

As illustrated in FIG. 4, the control unit 300 may include at least one of a power control unit 310 and a charging control unit 320.

The power control unit 310 may refer to a control device that monitors and controls the power unit 100.

The power control unit 310 may control power supply of the power unit 100 by applying a control signal to the power unit 100.

The power control unit 310 may control each of the first supply unit 110 and the at least one second supply unit 120 by applying a control signal to each of the first supply unit 110 and the at least one second supply unit 120.

The charging control unit 320 may refer to a control device that monitors and controls the electric vehicle charging unit 200.

The charging control unit 320 may control electric charging of the electric vehicle charging unit 200 by applying a control signal to the electric vehicle charging unit 200.

The control unit 300 may further include at least one component for controlling the control unit 300, in addition to the power control unit 310 and the charging control unit 320.

For example, the control unit 300 may further include a communication unit that performs communication with at least one communication target, a central operation unit that transmits control commands to the power control unit 310 and the charging control unit 320, respectively, etc.

The control unit 300 may control the operations of the first supply unit 110 and the one or more second supply units 120 to control power supply to the load L and the electric vehicle charging unit 200.

For example, the control unit 300 may control an amount of power that is to be supplied to the load L from any one of the first supply unit 110 and the at least one second supply unit 120.

The control unit 300 may receive information about status and operation from each of the first supply unit 110 and the at least one second supply unit 120, and control the operation of each of the first supply unit 110 and the at least one second supply unit 120 based on the received information.

For example, the control unit 300 may receive information about power capacity to be supplied from each of the first supply unit 110 and the at least one second supply unit 120, and control the operation of each of the first supply unit 110 and the at least one second supply unit 120, such that the first supply unit 110 and the at least one second supply unit 120 can supply power to the load L and the electric vehicle charging unit 200.

Meanwhile, when the at least one second supply unit 120 is plural, the control unit 300 may control power to be supplied and received between the plurality of second supply units 1200.

For example, the control unit 300 may control the fuel cell part 120#1 to supply power to the battery part 120#2 such that power is stored in the battery part 120#2, or control the renewable energy part 120#3 to supply power to the battery part 120#2 such that power is stored in the battery part 120#2.

The control unit 300 may control the operation of the electric vehicle charging unit 200 to control power charging to the electric vehicle EV.

For example, the control unit 300 may control charging ON/OFF, charging time point, charging capacity, charging time, charging cycle, etc. of the electric vehicle charging unit 200.

The control unit 300 may receive information regarding the status and operation from the electric vehicle charging unit 200 and control the operation of the electric vehicle charging unit 200 based on the received information.

For example, the control unit 300 may receive information regarding the number and charging capacities of target electric vehicles EVs to be charged, and control the operation of the electric vehicle charging unit 200 based on the received information such that the electric vehicle charging unit 200 charges the target electric vehicles EV with power.

The control unit 300 may also receive operation information from the load L, and control the operation of the load L or the operation of at least one of the power unit 100 and the electric vehicle charging unit 200 based on the received information.

The control unit 300 may also communicate with an external server ES outside the building to control the operation of the load L or the operation of at least one of the power unit 100 and the electric vehicle charging unit 200 based on information received from the external server ES.

Here, the external server ES may be at least one of a server of another system linked to the system G, a control server that communicates with the load L to control the load L, and a control server that controls the building.

Meanwhile, as illustrated in FIG. 2, the power system 1000 may further include a hydrogen vehicle charging unit 400 that receives hydrogen from the fuel cell part 120#1 and charges a target hydrogen vehicle HV to be charged with the received hydrogen.

The hydrogen vehicle charging unit 400 may receive hydrogen from the fuel cell part 120#1 under the control of the control unit 300 and charge the target hydrogen vehicle HV with the received hydrogen.

The hydrogen vehicle charging unit 400 may also receive hydrogen from a gas supply source through a gas pipe in the specific area and charge the target hydrogen vehicle HV with the received hydrogen.

In this way, when the gas supply source is disposed in the specific area, the control unit 300 may control the gas supply source to supply hydrogen to the fuel cell part 120#1, such that the hydrogen is charged in the fuel cell part 120#1.

In the power system 1000, the control unit 300 determines a predicted power consumption value of the load L and a predicted power charging value of the electric vehicle EV based on a power consumption history of the load L and a power charging history of the electric vehicle EV, and controls the operation of the at least one second supply unit 120 according to the predicted power consumption value and the predicted power charging value, thereby controlling power supply to the load L and power charging of the electric vehicle EV.

For example, when charging of the electric vehicle EV increases, the control unit 300 may control the power supply and power charging to be smoothly made by controlling the power supply of the power unit 100 in a manner of additionally operating at least one of the at least one second supply unit 120 or increasing an amount of power to be supplied from at least one of the at least one second supply unit 120 according to the predicted power consumption value and the predicted power charging value.

Here, the predicted power consumption value may mean an expected consumption value according to a power consumption pattern of the load L, and the predicted power charging value may mean an expected charging value according to a power charging pattern of the electric vehicle EV.

The control unit 300 may determine the power consumption pattern of the load L based on the power consumption history and determine the predicted power consumption value based on the power consumption pattern.

The control unit 300 may determine the power charging pattern of the electric vehicle EV based on the power charging history and determine the predicted power charging value based on the power charging pattern.

The control unit 300 may determine the predicted power consumption value and the predicted power charging value based on the power consumption history and the power charging history included in a pre-stored operation history.

In addition, the control unit 300 may receive the power consumption history from the load L or the external server ES, and receive the power charging history from the electric vehicle EV or the electric vehicle charging unit 200, to determine the predicted power consumption value and the predicted power charging value.

When the power system 1000 further includes the hydrogen vehicle charging unit 400, the control unit 300 may determine the predicted power consumption value, the predicted power charging value, and a predicted hydrogen charging value of the hydrogen vehicle HV based on the power consumption history, the power charging history, and a hydrogen charging history of the hydrogen vehicle HV, and control the operation of at least one of the at least one of the second supply unit 120 according to the predicted power consumption value, the predicted power charging value, and the predicted hydrogen charging value, thereby controlling power supply to the load L, power charging of the electric vehicle EV, and hydrogen charging of the hydrogen vehicle HV.

When the sum of the predicted power consumption value and the predicted power charging value exceeds a certain reference value, the control unit 300 may distribute a supply value to the load L and a charging value of the electric vehicle EV at a certain ratio, and control the power supply and power charging according to the distribution ratio.

Here, the certain reference value may be a reference capacity value preset in the control unit 300.

The certain reference value may be set to a rated allowable capacity value of the building.

Accordingly, when the sum exceeds the certain reference value, the control unit 300 may determine that the demands from the load L and the electric vehicle EV exceed the rated allowable capacity value, and thus distribute the supply value and the charging value at a certain ratio, thereby controlling the power supply and power charging.

For example, when the certain ratio is 3:1, the control unit 300 may distribute 75 [%] of total power supplied by the power unit 100 as the supply value, and the remaining 25 [%] as the charging value, to supply 75 [%] of the total power supplied from the power unit 100 to the load L and charge the electric vehicle EV with the remaining 25 [%].

When the control unit 300 distributes the supply value and the charging value at the certain ratio, the control unit 300 may distribute the supply value and the charging value according to at least one of the degree to which the sum exceeds the certain reference value and the ratio of the predicted power consumption value and the predicted power charging value.

For example, the control unit 300 may distribute the supply value and the charging value at the ratio of 2:1 when the sum exceeds the certain reference value by 10, and at the ratio of 3:1 when the sum exceeds the certain reference value by 20, or may distribute the supply value and the charging value according to the ratio of the predicted power consumption value and the predicted power charging value.

When distributing the supply value and the charging value at a certain ratio, the control unit 300 may determine a status level based on a real-time power consumption value of the load L and a real-time power charging value of the electric vehicle EV, and distribute the supply value and the charging value according to a reference ratio corresponding to the status level.

For example, the control unit 300 may classify the status into available/normal/risk/emergency levels and determine the status according to the real-time power consumption value and the real-time power charging value, and distribute the supply value and the charging value according to a reference ratio corresponding to the determined level.

Additionally, the control unit 300 may control the operation of the at least one second supply unit 120 according to a criteria corresponding to the status level.

For example, in the case where the operation control of the entire at least one second supply unit 120 is set for an emergency level, when the sum of the real-time power consumption value and the real-time power charging value corresponds to the emergency level, the control unit 300 may control all the at least one second supply unit 120 to supply power.

When controlling the operation of the at least one second supply unit 120, the control unit 300 may calculate a virtual inertia according to the operation of a target supply unit to be operated based on information on the statuses of the system G, the electric vehicle charging unit 200, and the power unit 100, and operate the target supply unit for the power supply and power charging by reflecting the virtual inertia.

The virtual inertia may mean a parameter or a control command value for suppressing fluctuations in existing power supply due to coupling between power sources.

From this perspective, the virtual inertia may also mean a compensation parameter that compensates for fluctuations in supply power when coupling between power sources.

That is, when controlling the operation of the at least one of the at least one second supply unit 120, the control unit 300 may control the operation of the at least one second supply unit 120 by reflecting the virtual inertia, to suppress the fluctuations in power supplied from the first supply unit 110 due to the operation of the at least one of the at least one second supply unit 120 which is a supply source different from the first supply unit 110.

This can suppress the fluctuations in power supply due to the operation of the at least one of the at least one second supply unit 120, by virtue of the reflection of the virtual inertia.

For example, when the renewable energy part 120#3 among the at least one second supply unit 120 is additionally operated, the control unit 300 may control the additional operation of the renewable energy part 120#3 based on the virtual inertia, so as to suppress fluctuations in power supply due to the additional operation of the renewable energy part 120#3.

The control unit 300 may calculate the virtual inertia based on information about at least one of voltage, current, power, frequency, power factor, and load of each of the system G and the power unit 100.

The control unit 300 may calculate the virtual inertia as a value that power supplied from the target supply unit to be operated is synchronized with power supplied from the first supply unit 110.

For example, the control unit 300 may calculate the virtual inertia so that the frequency of the power supplied from the target supply unit is synchronized with a frequency of commercial power supplied from the first supply unit 110.

In this way, the control unit 300, which calculates the virtual inertia and reflects the calculated virtual inertia in the operation of at least one of the plurality of second supply units 120, may determine the target supply unit to be operated according to the real-time power consumption value of the load L and the real-time power charging value of the electric vehicle EV, and thus operate the target supply unit to operate for the power supply and the power charging.

For example, the control unit 300 may determine at least one of the at least one second supply unit 120 as the target supply unit to be operated according to the real-time power consumption value and the real-time power charging value, and operate the target supply unit to be operated for the power supply and the power charging.

As a specific example, when the real-time power consumption value and the real-time power charging value are below a certain reference, the control unit 300 may determine a supply unit, which has the least operating burden among the at least one second supply unit 120, as the target supply unit to be operated. Or when the real-time power consumption value and the real-time power charging value exceed the certain reference, the control unit 300 may determine a supply unit with the largest output power as the target supply unit to be operated.

When the control unit 300 determines the supply unit to operate, the control unit 300 may calculate the virtual inertia according to the supply unit to operate, and control the power supply and power charging by reflecting the virtual inertia in the supply unit to operate.

Meanwhile, the control unit 300 may monitor changes in the virtual inertia and control the operation of the power supply and power charging in response to the changes in the virtual inertia.

For example, the control unit 300 may decrease the supply value and charging value of the target supply unit to be operated when the virtual inertia increases, and increase the supply value and charging value of the target supply unit to be operated when the virtual inertia decreases.

The control unit 300 may adjust the reflection of the virtual inertia when the virtual inertia falls within a certain reference range.

Here, the reference range may be a range including a limit value of the virtual inertia or a range including an allowable value.

When the virtual inertia corresponds to the reference range, the control unit 300 may reduce the reflected value of the virtual inertia and reflect it in the operation of the target supply unit to be operated.

That is, when the virtual inertia falls within the reference range, the control unit 300 may determine that the virtual inertia has reached a limit or allowable value, and may reflect the virtual inertia by reducing the reflected value of the virtual inertia that is reflected in the operation of the target supply unit to be operated.

Additionally, when the virtual inertia corresponds to the reference range, the control unit 300 may generate notification information regarding the virtual inertia corresponding to the reference range.

That is, when the virtual inertia corresponds to the reference range, the control unit 300 may determine that the virtual inertia has reached a limit or allowable value and generate the notification information.

The control unit 300 may control the notification information to be displayed externally.

For example, the notification information may be controlled to be displayed on a screen through a display module (means) or to be output with voice through an audio output module (means).

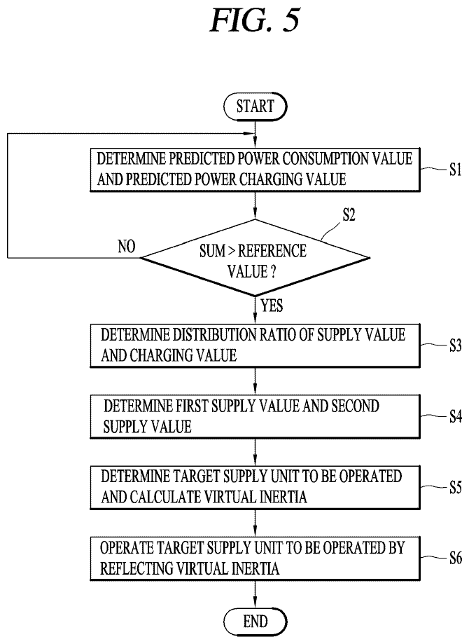

A specific process in which the control unit 300 performs control in the power system 1000 as described above may be performed in the order illustrated in FIG. 5.

As illustrated in FIG. 5, the control unit 300 may determine the predicted power consumption value and the predicted power charging value based on the power consumption history and the power charging history (S1), and compare the sum of the predicted power consumption value and the predicted power charging value with the certain reference value (S2).

As a result of comparing the sum with the certain reference value (S2), the control unit 300 may determine the distribution ratio of the supply value and the charge value when the sum exceeds the certain reference value (S3), and maintain the existing control when the sum does not exceed the certain reference value.

After determining the distribution ratio of the supply value and the charge value (S3), the control unit 300 may determine a first supply value to be supplied from the first supply unit 110 and a second supply value to be supplied from the plurality of second supply units 120 (S4).

After determining the first supply value and the second supply value (S4), the control unit 300 may determine a target supply unit to be operated among the plurality of second supply units 120 according to the second supply value, and calculate the virtual inertia according to the target supply unit to be operated (S5).

After determining the target supply unit to be operated and calculating the virtual inertia (S5), the control unit 300 may operate the target supply unit to be operated by reflecting the virtual inertia (S6).

According to this process, as the operation of the target supply unit to be operated is performed in a state in which the virtual inertia has been reflected, the first supply unit 110 may supply the first supply value, and at least one of the plurality of second supply units 120 including the target support unit to be operated may supply the second supply value, thereby enabling the power supply and the power charging.

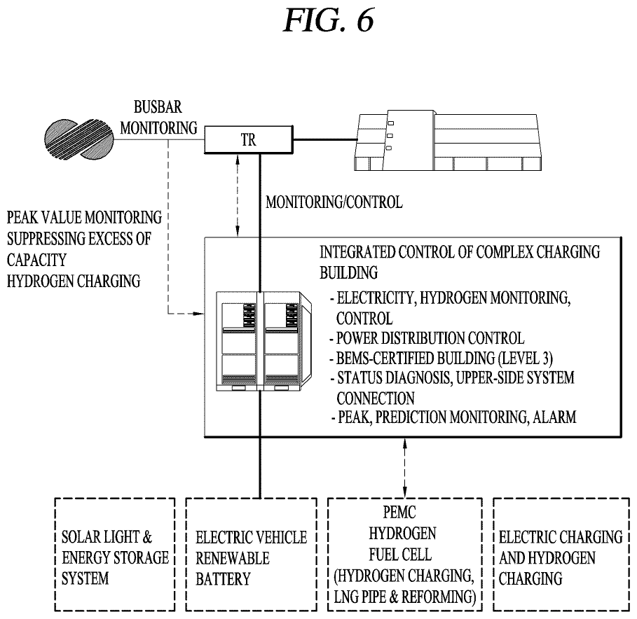

The embodiment of the power system 1000 described above may be applied to the system illustrated in FIG. 6 or may be implemented as the system illustrated in FIG. 6.

As illustrated in FIG. 6, the power system 1000 may be applied to a building that includes electric vehicle/hydrogen vehicle charging facilities while general loads coexist, receives power from a system, and includes a plurality of heterogeneous power supply sources to receive power from the power supply sources, or may be implemented as the power system of the building. The power system 1000 can be applied to a building equipped with electric vehicle/hydrogen vehicle charging facilities where general loads coexist or can be implemented as the power system of such building.

An integrated control unit monitors system busbars and also monitors power facilities of a charging building where general loads coexist. The integrated control unit analyzes and predicts a pattern of the general loads of the charging building and predicts an existing charging pattern. When the sum of the predicted results is less than a preset allowable capacity of the power facilities, every power facility operates normally. When the sum of the predicted results exceeds the preset allowable capacity of the power facilities, the power facilities operate in a power distribution mode. In the power distribution mode, statuses are classified into emergency/warning situation/normal situation/available situation based on a real-time power sum value and a capacity value. In the case of the warning situation, charging is performed by turning on/off a slow charger in real time through Stop&Go when having an approximate value with respect to the emergency. In the case of the normal situation, charging of the loads and electric vehicles are carried out without problems.

Meanwhile, in the case of the emergency, charging of electric vehicles with all energy sources may be terminated or other energy sources may be used to deal with such situation.

If it is needed to operate a hydrogen fuel cell or meet hydrogen charging requirements, LNG gas may be reformed to produce and store hydrogen in a fuel cell for use. In addition, solar charging actively operates in conjunction with load demands and ESS, and may receive power from hydrogen fuel cells when necessary.

Meanwhile, large voltage changes may occur within the system due to rapid renewable output, sudden hydrogen reforming, and fuel cell operation. In response to this, an AC-UPS-based virtual inertia that can respond to instantaneous fluctuations to maintain frequency synchronization can be reflected, resulting in performing charging of electric vehicles and power supply to general loads.

The preferred embodiment of the present disclosure described above has been disclosed to solve technical problems, and it should be understood that those skilled in the art can make various modifications, changes, additions, etc. within the spirit and scope of the present disclosure, and such modifications are embraced within the scope of the claims below.

### Description of Reference Numerals

100: Power unit 200: Charging unit
300: Control unit 1000: Power system

1. A power system comprising:
a power unit that supplies power to a load within a specific area;
an electric vehicle charging unit that receives power from the power unit and charges an electric vehicle to be charged; and
a control unit that monitors power consumption of the loads and charging of the electric vehicle and controls operations of the power unit and the electric vehicle charging unit,
wherein the power unit comprises:
a first supply unit that receives commercial power from a system connected to the specific area; and
at least one second supply unit that is installed in the specific area to supply its own power,
the control unit determines a predicted power consumption value of the load and a predicted power charging value of the electric vehicle based on a power consumption history of the load and a power charging history of the electric vehicle, and controls an operation of the at least one second supply unit according to the predicted power consumption value and the predicted power charging value, so as to control a power supply to the load and power charging of the electric vehicle.

2. The power system of claim 1, wherein the at least one second supply unit comprises at least one of:
a fuel cell part;
a battery part; and
a renewable energy part.

3. The power system of claim 2, wherein the control unit distributes a supply value to the load and a charging value of the electric vehicle at a certain ratio when a sum of the predicted power consumption value and the predicted power charging value exceeds a certain reference value, and controls the power supply and power charging according to the distributed ratio.

4. The power system of claim 3, wherein when distributing the supply value and the charging value at the certain ratio, the control unit distributes the supply value and the charging value according to at least one of a degree to which the sum exceeds the certain reference value and a ratio of the predicted power consumption value and the predicted power charging value.

5. The power system of claim 3, wherein when distributing the supply value and the charging value at the certain ratio, the control unit determines a status level based on a real-time power consumption value of the load and a real-time power charging value of the electric vehicle, and distributes the supply value and the charging value according to a reference ratio corresponding to the status level.

6. The power system of claim 2, wherein the at least one second supply unit is provided in plurality each comprising at least two of:
the fuel cell part;
the battery part; and
the renewable energy part, each provided by at least one, and
the control unit controls an operation of at least one of the plurality of second supply units.

7. The power system of claim 6, wherein the control unit controls power to be received and supplied between the plurality of second supply units.

8. The power system of claim 1, wherein when controlling the operation of the at least one second supply unit, the control unit calculates a virtual inertia according to an operation of a supply unit to be operated based on information about statuses of the system, the electric vehicle charging unit, and the power unit, and operates the supply unit to be operated for the power supply and the power charging by reflecting the virtual inertia.

9. The power system of claim 8, wherein the control unit calculates the virtual inertia based on information related to at least one of voltage, current, power, frequency, power factor, and load of each of the system and the power unit.

10. The power system of claim 9, wherein the control unit calculates the virtual inertia as a value that power supplied by the supply unit to be operated is synchronized with power supplied by the first supply unit.

11. The power system of claim 10, wherein the control unit determines the supply unit to be operated according to a real-time power consumption value of the load and a real-time power charging value of the electric vehicle, and operates the supply unit to be operated for the power supply and the power charging.

12. The power system of claim 8, wherein the control unit monitors changes in the virtual inertia and controls the operation of the power supply and the power charging in response to the changes in the virtual inertia.

13. The power system of claim 12, wherein the control unit, when the virtual inertia corresponds to a certain reference range, generates notification information about the virtual inertia corresponding to the reference range and controls the notification information to be displayed externally.

14. The power system of claim 1, wherein the at least one second supply unit comprises at least a fuel cell part, and
the power system further comprises a hydrogen vehicle charging unit that receives hydrogen from the fuel cell unit and charges the hydrogen to a hydrogen vehicle to be charged.

15. The power system of claim 14, wherein the control unit determines the predicted power consumption value, the predicted power charging value, and a predicted hydrogen charging value of the hydrogen vehicle based on the power consumption history, and the power charging history, and a hydrogen charging history of the hydrogen vehicle, and controls the operation of the at least one second supply unit according to the predicted power consumption value, the predicted power charging value, and the predicted hydrogen charging value, so as to control the power supply to the load, the power charging of the electric vehicle, and hydrogen charging of the hydrogen vehicle.
